(19) United States
(12) Patent Application Publication
(10) Pub. No.: US 2025/0165847 A1
(43) Pub. Date: May 22, 2025

(54) METHOD FOR SIMULATING A QUANTUM MECHANICAL SYSTEM BY MEANS OF A NOISY QUANTUM COMPUTER

(71) Applicant: HQS Quantum Simulations GmbH, Karlsruhe (DE)

(72) Inventors: Juha Leppäkangas, Karlsruhe (DE); Michael Marthaler, Karlsruhe (DE); Sebastian Zanker, Karlsruhe (DE)

(21) Appl. No.: 18/842,485

(22) PCT Filed: Feb. 3, 2023
(86) PCT No.: PCT/DE2023/100089

§ 371 Date: Aug. 29, 2024

(30) Foreign Application Priority Data
Mar. 3, 2022 (DE) 10 2022 105 095.5

(51) Int. Cl. G06N 10/80

(52) U.S. Cl. CPC G06N 10/80

(57) ABSTRACT

Quantum computers can be used to solve certain mathematical problems which are unsolvable for conventional computers. However, the construction of a large-scale quantum computer is associated with numerous technical difficulties. Therefore, although in principle it is possible to solve quantum problems using quantum computers, the quality of the simulation suffers from the noise inherent in the quantum computer hardware, in particular the quantum elements. It is therefore the object of the invention described here to make use of the noise resulting from the hardware of a quantum computer to solve a quantum mechanical system or a quantum mechanical problem. The method according to the invention achieves this by dividing the quantum mechanical system to be simulated into a core and into a bath, mapping the core onto the at least one qubit and the bath onto the at least one quantum element of the quantum computer, and assigning the noise of the at least one quantum element to at least part of the quantum mechanical system, in particular to the bath.

### REFERENCE TO PENDING PRIOR PATENT APPLICATIONS

This patent application is a 371 national stage entry of pending prior International (PCT) Patent Application No. PCT/DE2023/100089, filed 3 Feb. 2023 by HQS Quantum Simulations GmbH for METHOD FOR SIMULATING A QUANTUM MECHANICAL SYSTEM BY MEANS OF A NOISY QUANTUM COMPUTER, which patent application, in turn, claims benefit of German Patent Application No. 10 2022 105 095.5, filed 3 Mar. 2022.

The two (2) above-identified patent applications are hereby incorporated by reference.

### FIELD OF THE INVENTION

The invention relates to a method for simulating a quantum mechanical system by means of a noisy quantum computer, which has at least one qubit and at least one quantum element, wherein, in the simulation of the quantum mechanical system, the quantum mechanical system is assigned to the noisy quantum computer, and a measured variable of the quantum mechanical system is determined. Furthermore, the invention relates to a quantum computer for executing the method according to the invention.

### BACKGROUND OF THE INVENTION

Quantum computers can be used to simulate quantum mechanical systems such as molecules, but also for fundamental quantum mechanical questions—for example, in areas of quantum field theory. Conventional computers can simulate quantum mechanical systems only for very small problems or by means of approximation methods.

A quantum computer is a technically well-controllable quantum device the calculations of which are based upon using the laws of quantum mechanics. The basic unit of the quantum computer is the qubit. Like the known classical bit, the qubit can also assume the values 0 and 1. The crucial difference from the classical states is that the qubit or a system of qubits can be in any quantum mechanical superposition and/or quantum mechanical entanglement of the possible bit sequences. It follows that a quantum register of N qubits encodes the information of 2^{N} variables. The ability to create such an exponentially large parameter space exceeds the computing power of a conventional computer.

Similar arguments reveal that simulating quantum mechanical systems with conventional computers requires the use of approximation methods, since, otherwise, the resource requirements grow exponentially with the size of the simulated system. Although these approximations can still produce very accurate results, they are highly dependent upon the particular system. A large amount of time must therefore be spent to find an optimal approximation for a given quantum mechanical system.

A sufficiently large and well-functioning quantum computer can be used to solve certain mathematical problems that cannot be solved by classical computers. Such problems in particular include the simulations of other quantum mechanical systems. It is widely recognized that the quantum computer will be a revolutionary research tool for both basic science and industry, since it makes possible the development and discovery of new materials with commercially relevant properties, such as magnetism, specific coupling with light, or superconductivity. In fact, it has already been shown theoretically that, even with a small number of qubits, quantum simulation algorithms are faster than any conventional computer.

However, the construction of a large-scale quantum computer is associated with numerous technical difficulties. The biggest difficulty is isolating a quantum computer from its environment, which leads to errors or noise of the quantum computer or the qubits and quantum elements. Not all sources of noise occurring in a quantum computer are known, but some important examples in particular include non-equilibrium states of hardware materials, impurities that arise in the production process, local fluctuations that can arise on surfaces and between different materials during the production process, and residual thermal excitations.

Therefore, although it is in principle possible to solve quantum problems using quantum computers, the quality of the simulation suffers from the noise inherent in the quantum computer hardware, in particular the qubits and the quantum elements.

### SUMMARY OF THE INVENTION

It is therefore the object of the invention described here to make use of the noise resulting from the hardware of a quantum computer to solve a quantum mechanical system or a quantum mechanical problem. This object is achieved by a method according to the applicable claim 1. Furthermore, the object is achieved by a noisy quantum computer according to the subordinate device claim 18. Advantageous embodiments of the invention can be taken from the dependent claims and the description.

In the method according to the invention, the noise inherent in the quantum computer hardware is assigned to the problem to be solved. This intrinsic noise of the quantum computer hardware therefore no longer hinders the simulation, but, rather, itself becomes part of the simulation. This can make it possible to use noisy quantum computers to solve problems in quantum mechanics.

The method disclosed in the invention described here thus makes it possible, for example, to use the noise of a NISQ (noisy intermediate-scale quantum) computer to carry out non-trivial material simulations and quantum mechanical simulations that cannot be carried out by other means, be they conventional computers or NISQ quantum computers, without this method. This not only makes it possible to carry out simulations of quantum mechanical systems on a quantum computer, but also increases the complexity of the systems that can be solved on the quantum computer.

The consideration behind the last point is that the resources required for simulating open quantum systems, i.e., systems coupled to an environment/noise source, are generally considerably larger in comparison to simulating a closed system, since the complexity of an open system is approximately equal to that of a closed system twice as large.

In general, the noise or error susceptibility of a quantum computer can be characterized by the decoherence rate γ.

The decoherence rate corresponds to a characteristic time in which the information stored in a qubit or in a quantum element is lost, tₗₒₛₜ=1/γ. The noise and the corresponding decoherence rate is generally divided into three specific parts, one of which leads to qubit decay (at the rate γ_{dec}), to qubit dephasing (at the rate γ_{deph}), and to qubit depolarization (at the rate γ_{depo}). Decay drives the qubits into the lowest energy state and can also be understood as cooling, while dephasing destroys the coherent information stored in a qubit register and puts the quantum computer into a classical state. Depolarization corresponds to randomization, i.e., the irregular arrangement of information, and can also be understood as warming in this connection.

Currently, noise is dominated in superconducting quantum computers by qubit decay, and in ion-trap quantum computers by qubit dephasing and depolarization.

Gate-based or digital quantum simulation is considered here. In gate-based quantum simulation, the temporal evolution of the system is reproduced by fast control signals on physical qubits. The simulated system is described by the Hamiltonian H, which is based upon basis states of the original problem. The quantum simulation generated by the quantum computer is determined by the Hamiltonian Hoc (T) acting upon the qubits of the quantum computer, where τ is the real time. These two Hilbert spaces are equivalent, i.e., there is a mapping of the quantum simulation to the original system.

The quantum simulation is designed to reproduce the temporal evolution of the system (operator) in a certain satisfactory approximation,

$$U ( t ) = exp [ - iHt ] \approx {U}_{QC} ( t ) = T exp [ - i {\int }_{0}^{τ} {dt}^{′} {H}_{QC} ( {τ}^{′} ) ] .$$

Here, ℏ=1 is used as the unit. U (t) is the simulated time evolution of the system, while U_{QC}(τ′) is the physical time evolution of the quantum computer due to the control pulses mentioned above. Tis the time ordering operator required to mathematically describe the correct time evolution of a time-dependent quantum mechanical system. H is the Hamiltonian operator of the quantum system to be simulated. H_{QC}(τ) is the Hamiltonian operator of the quantum computer.

The gate-based quantum time evolution is constructed from successive applications of generally identical sequences of quantum operations, each representing a small time evolution over time dt. This process is also called Trotter expansion. In the case of a time-independent Hamiltonian, each sequence executes the same operation:

$${U}_{QC} ( dt ) = {\prod }_{parts} exp ( - {iH}_{part} dt ) .$$

Here, the term H is split into parts according to H=Σₚₐᵣₜ Hₚₐᵣₜ with corresponding unitary transformations, exp (−iHₚₐᵣₜdt), which can be executed on a quantum computer. All parts together cover all terms in the original Hamiltonian, and the multiplication takes place in a chosen order, e.g., by sorting the Hamiltonian into commuting term sets or by choosing a higher-order Trotter expansion. The entire temporal evolution over time t can then be described, for example, as follows:

$${U}_{QC} ( t ) = {[ {U}_{QC} ( dt ) ]}^{n} ,$$

where t=ndt.

Instead of generating the entire temporal evolution by applying fast control pulses, which are described by the Hamiltonian H_{QC}(t), it is also possible to combine the digital or gate-based part of the quantum computer with a certain set of static terms H_{static}.

Static terms could be realized with linear elements such as resonators, nonlinear elements such as Josephson junctions, or qubits. All potential elements that generate static terms are called quantum elements herein. These quantum elements can continuously evolve or change in real time, i.e., they behave like analog quantum mechanical components. The coupling between static and digital parts can take place digitally, e.g., by switching the coupling between qubits and static quantum elements on and off as part of the digital simulation, or the coupling can always be switched on while the digital evolution of the qubits is applied.

The quantum simulation is designed to reproduce the temporal evolution of the quantum mechanical system (operator) in a certain satisfactory approximation,

$$U = exp [ - iHt ] \approx {U}_{QC} ( t ) = T exp \{ i {\int }_{0}^{t} {dt}^{′} [ {H}_{QC} ( {t}^{′} ) + {H}_{static} ] \} .$$

Here, too, ℏ=1 is used as the unit.

The method according to the invention serves to simulate a quantum mechanical system by means of a noisy quantum computer, which has at least one qubit and at least one quantum element. The simulation of the quantum mechanical system is allotted to both the at least one qubit and the at least one quantum element. In both cases, the noise of the at least one qubit or of the at least one quantum element is mapped to aspects of the system to be simulated. The case in which the qubits are almost noise-free and noise is present only in the quantum elements is extremely promising.

First, the quantum system to be simulated is defined. Two possibilities for defining the system come into consideration.

A first possibility is to divide the system into a core and a bath.

$$H = {H}_{core} + {H}_{bath} + {H}_{coupling} .$$

Examples of H_{core} include

$${H}_{core} = \{ \begin{matrix}{\sum }_{a} {\vec{B}}_{a} {\vec{S}}_{a} + {\sum }_{ab} {\sum }_{c d} {{{U}_{ab}^{c d} [ {\vec{S}}_{a} ]}_{c} [ {\vec{S}}_{b} ]}_{d} , & spin system \\ {\sum }_{ab} {t}_{ab} {\hat{c}}_{a}^{†} {\hat{c}}_{b} + {\sum }_{abcd} {U}_{abcd} {\hat{c}}_{a}^{†} {\hat{c}}_{c}^{†} {\hat{c}}_{d} {\hat{c}}_{b} , & interacting fermions\end{matrix}$$

For the spin system, [\vec{S}ₐ]_{c} is the c-th component of the spin operator (with c=x, y, z) that acts upon the spin a, \vec{B}ₐ is a magnetic field coupling to the spins, and U_{ab}^{cd} describes the coupling between the c- and d-components of the spins a and b. For the fermionic system, ĉₐ (ĉₐ^{†}) is the fermionic annihilator (generator) acting upon the orbital a, t_{ab} is the hopping parameter between the orbitals a and b or, for a=b, the orbital energy, while U_{abcd} is the interaction between the electrons, e.g., through Coulomb repulsion. The index a, b, . . . of an electronic generator or annihilator can include different quantum numbers. For example, a combination of spatial orbital or energy orbital and spin index a=(k, σ), where σ=↑↓ describes the spin of the electron. In such a case, the orbital a is also called a spin orbital.

Examples of H_{bath} include

$${H}_{bath} = \{ \begin{matrix}{\sum }_{i} {ω}_{i} {\hat{b}}_{i}^{†} {\hat{b}}_{i} , & bosonic bath \\ {\sum }_{i} {∈}_{i} {\hat{c}}_{i}^{†} {\hat{c}}_{i} , & fermionic bath\end{matrix}$$

where \hat{b}ᵢ(\hat{b}ᵢ^{†}) is the bosonic annihilator (generator) acting upon mode i, and ωᵢ is the energy of bosonic mode i. Depending upon the composition of the core and the bath, the coupling Hamiltonian can, for example, take the following forms

$${H}_{coupling} = \{ \begin{matrix}{\sum }_{{aa}^{′} i} {t}_{{aa}^{′} i} {\hat{c}}_{a}^{†} {\hat{c}}_{{a}^{′}} ( {\hat{b}}_{i}^{†} + {\hat{b}}_{i} ) , & fermionic core and bosonic bath \\ {\sum }_{abi} {{t}_{abi} [ {\vec{S}}_{a} ]}_{b} ( {\hat{b}}_{i}^{†} + {\hat{b}}_{i} ) , & spin core and bosonic bath \\ {\sum }_{abij} {{t}_{abij} [ {\vec{S}}_{a} ]}_{b} {\hat{c}}_{i}^{†} {\hat{c}}_{j} , & spin core and fermionic bath \\ {\sum }_{{aa}^{′} ∈ core} {\sum }_{ij ∈ bath} {t}_{{aa}^{′} ij} {\hat{c}}_{a}^{†} {\hat{c}}_{{a}^{′}} {\hat{c}}_{i}^{†} {\hat{c}}_{j} , & fermionic core and fermionic bath\end{matrix}$$

It should be noted that it may be simpler to execute the model on a quantum computer if the coupling in core orbitals is diagonal (a=a′).

Another possibility could be to assume a completely fermionic system,

$${H}_{f} = {\sum }_{qr} {t}_{qr} {c}_{q}^{†} {c}_{r} + {\sum }_{qrst} {U}_{qrst} {c}_{q}^{†} {c}_{s}^{†} {c}_{t} {c}_{r}$$

which is likewise divided into a core and a bath. For this purpose, a group of orbitals can be defined, which comprise the core and a group of orbitals that form the bath. The most important aspect of this choice is the need to find orbital subspaces between which no particles are exchanged. The number of electrons in the core and in the bath thus remains constant. In order to achieve this, it may be necessary to decouple core and bath, i.e., to make a certain choice for the orbitals or, for example, to carry out a Schrieffer-Wolff transformation.

The Schrieffer-Wolff transformation is a systematic approach to determining a unitary rotation of the Hamiltonian on a many-body basis, in which the Hamiltonian becomes block diagonal. This uniform rotation can be constructed such that the number of particles in the core and in the bath in each of the blocks of the Hamiltonian is fixed after the rotation.

In such a basis, it is possible to identify orbitals that behave in a spin-like manner, i.e., if necessary, the interacting fermionic system can be transformed into a spin system coupled to a fermionic bath by assigning the orbitals identified as spin-like to the core and the non-spin-like orbitals to the bath.

The Hamiltonian in this basis therefore does not lead to a particle exchange between the core and the bath if, for example, the orbitals in the core are singly occupied. The terms of the Hamiltonian in the original basis, which would have allowed particle exchange between core and bath, now appear as energy corrections and effective interactions between states within the same block of the rotated Hamiltonian. In the first known application of the Schrieffer-Wolff transformation, a model of an interacting impurity orbital coupled to a non-interacting bath by particle exchange, the so-called single-impurity Anderson model (SIAM), is transformed into a model of a localized spin coupled to the electronic orbitals by a particle number-conserving, antiferromagnetic Heisenberg interaction.

The Hamiltonian H of the SIAM can be separated into terms H₀, which leave the particle numbers of the impurities and of the bath unchanged, and terms V, which exchange particles between the impurity and the bath:

$$H = {H}_{0} + V$$

$${H}_{0} = {\sum }_{σ} {ε}_{d} {d}_{σ}^{†} {d}_{σ} + U ( {n}_{↑} - \frac{1}{2} ) ( {n}_{↓} - \frac{1}{2} ) + {\sum }_{k σ} {ε}_{k} {c}_{k σ}^{†} {c}_{k σ} ,$$

$$V = {\sum }_{k σ} {V}_{k σ} {d}_{σ}^{†} {c}_{k σ} + {V}_{k σ}^{*} {c}_{k σ}^{†} {d}_{σ} ,$$

where the rotation generator S of the rotating Hamiltonian \tilde{H} can be given by

$$\tilde{H} = {U}^{†} HU = {e}^{S} {He}^{- S} .$$

The exact calculation of the matrix product for the rotation is generally not feasible, so that it can be approximated by a Campbell-Baker-Hausdorff expansion, which can be:

$${e}^{S} {He}^{- S} = {\sum }_{m = 0}^{∞} {\frac{1}{m !} [ S , H ]}_{m} ,$$

where [S,H]ₘ=[S, [S, . . . [S,H]]] with m commutators and [S, H]ₘ₌₀. In its simplest form, the Schrieffer-Wolff transformation truncates the series expansion after the correction of the leading order. The resulting effective Hamiltonian is then given by

$$\tilde{H} = {H}_{0} + V + [ S , {H}_{0} ] + [ S , V ] .$$

By finding a rotation generator S that satisfies the conditions,

$$[ S , {H}_{0} ] = - V$$

it is possible after the rotation to obtain an effective Hamiltonian, which no longer contains terms that facilitate the particle exchange between impurities and bath. Processes relating to the particle exchange between impurity and bath can be captured by correction terms generated by [S,V]. These processes can be processes in which a particle is transferred from the impurity to the bath, and a particle from the bath with opposite spin is transferred to the impurity, which causes a spin flip at the impurity site.

In the case of a SIAM model, the following generator is, for example, a good approach:

$$S = {\sum }_{k σ} \frac{{V}_{k σ}}{{ε}_{d} - {ε}_{k}} ( {c}_{k σ}^{†} {d}_{σ} - {d}_{σ}^{†} {c}_{k σ} ) + ( \frac{{V}_{k σ}}{{ε}_{d} - {ε}_{k} + U} - \frac{{V}_{k σ}}{{ε}_{d} - {ε}_{k}} ) {n}_{d \overline{σ}} ( {c}_{k σ}^{†} {d}_{σ} - {d}_{σ}^{†} {c}_{k σ} ) .$$

which, after rotation, results in an effective Hamiltonian of a Kondo model, in which a localized spin interacts with a bath of spins via an antiferromagnetic Heisenberg interaction. For a generic system that can be divided into a core and a bath, an individual rotation generator must be determined, which must satisfy the equation [S, H₀]=−V.

In addition, the bath can be described by a molecular field theory approximation, so that the bath can be considered to be non-interacting.

The aim here is to eliminate any possible interactions in the bath. This is also necessary in order to make the unified representation possible. The indices {a,b,c,d} can be defined to describe the orbitals in the core, and {i,j} can be defined to describe the orbitals in the bath. Based thereon, the Hamiltonian H_{ƒ}=Σ_{qr}t_{qr}c_{q}^{†}cᵣ+Σ_{qr st}U_{qr st}c_{q}^{†}cₛ^{†}cₜcᵣ, can be formulated as follows:

$${H}_{f} = {H}_{core} + {H}_{b a t h} + {H}_{coupling}$$

$$with$$

$${H}_{core} = {\sum }_{ab} {\tilde{t}}_{a b} {\hat{c}}_{a}^{†} {\hat{c}}_{b} + {\sum }_{a b c d} {U}_{abcd} {\hat{c}}_{a}^{†} {\hat{c}}_{c}^{†} {\hat{c}}_{d} {\hat{c}}_{b}$$

$${H}_{bath} = {\sum }_{i} {∈}_{i} {\hat{c}}_{i}^{†} {\hat{c}}_{i}$$

$${H}_{coupling} = {\sum }_{ab ∈ core} {\sum }_{ij ∈ bath} {t}_{abij} {\hat{c}}_{a}^{†} {\hat{c}}_{b} {\hat{c}}_{i}^{†} {\hat{c}}_{j}$$

Thus, all terms that exchange particles between core and bath have been transformed away or neglected, and ∈ᵢ is found by applying the molecular field theory approximation to the degrees of freedom in the bath.

It is also conceivable for the core to consist of spins. This is the case when there are orbitals that have one spin degree of freedom and are occupied by exactly a single electron. An orbital with one spin degree of freedom can be occupied by zero electrons |0ᵢ>, one electron with either spin-up |↑ᵢ> or spin-down |↓ᵢ> or two electrons with opposite spins |↑ᵢ↓ᵢ>. As described above, electronic generators and annihilators can have one spin degree of freedom, e.g., c_{i,↑} would remove an electron with spin-up from the orbital i. If mainly the states spin-up |↑ᵢ> or spin-down |↓ᵢ> are occupied, the particle exchange can be neglected, and the orbital can be considered to be spin-like. In order to be able to determine these spin-like orbitals, the invention proposes to distinguish between truly singly occupied orbitals and orbitals with an average occupation of 1. The latter are orbitals in which the projection of the low-energy wave functions onto the local eigenbasis can also contain significant contributions both from local eigenstates without electrons in orbital i (|0ᵢ>) and from two electrons, one with spin-up and one with spin-down, in orbital i (|↑↓ᵢ>).

Therefore, it may be advantageous to measure the local parity of orbitals, which can be given by

$${P}_{i} = {( - 1 )}^{{n}_{↑ i} + {n}_{↓ i}} = ( 1 - 2 {n}_{↑ i} ) ( 1 - 2 {n}_{↓ i} )$$

where the parity can here assume the values <↑ᵢ|Pᵢ|↑ᵢ>=−1=<↓ᵢ|Pᵢ|↓ᵢ> and <0ᵢ|Pᵢ|0ᵢ>=+1=<↑↓ᵢ|Pᵢ|↑↓ᵢ>. For orbitals for which the parity |−1−Pᵢ|<ϵ is satisfied, it can be assumed that they behave like spins. These orbitals are assigned to the core. The value of E can be chosen and controls the precision of how spin-like an orbital is. For the remaining orbitals of the Hilbert space, orbital rotations can be carried out with the aim of minimizing the parity of a selected number of orbitals. If additional orbitals that likewise satisfy |−1−Pᵢ| <ϵ are constructed in this way, the corresponding orbitals can be added to the core. Orbitals with the parity |−1−Pᵢ|>ϵ can be assigned to the bath, even if the expectation value of their occupation is <n_{↑i}+n_{↓i}>=1.

A very common criterion for the division into core and bath is that the core contains a relatively small number of degrees of freedom in comparison to the bath and is dynamically active. The bath in turn has a large number of states, each of which couples with an amplitude very similar to that of the core.

Furthermore, a uniform description of the bath as a bosonic bath can be achieved. As described above, the bath can consist of non-interacting fermions or non-interacting bosons. If the bath consists of fermions, the operator that couples to the bath has the form

Ô_{i,j}=ĉᵢ^{†}ĉⱼ,

where i, j∈bath, and it can be assumed that i≠j. The following property of the bath coupling operator can be considered:

$$[ {\hat{O}}_{i j} , {\hat{O}}_{k l} ] = 0 , if i \neq l and j \neq k$$

This can be understood as a bosonic exchange symmetry, i.e., the composite operators cᵢ^{†}cⱼ can behave similarly to bosonic operators. It can be deduced therefrom that, if a large number of relevant bath orbitals are present, the bosonic commutation relation can also apply to the entire core-bath coupling.

There can be two possible conditions that actually allow this assumption. Firstly, bath orbitals that interact with the same process in the core do not couple directly with one another. Secondly, bath decay rates are greater than the core-bath coupling.

An example of the first condition can be a tunnel junction that has a large number of conduction channels or a large number of angular momentum states of a molecule. In contrast, a bath with a broad spectral density can be an example of the second condition. In such situations, the exchange interaction between fermions can be neglected, and the bath behaves like a bosonic field (as seen from the core). This approach can essentially be compared with a Gaussian approximation for the equilibrium statistics of the bath coupling operator.

The coupling scheme at the Hamiltonian level can include boson generation and annihilation processes. For example, for modeling a fermion core coupled to a fermion bath, the following mapping can be assumed:

$${\sum }_{ij} = {t}_{aaij} {\hat{O}}_{i j} ≡ {\sum }_{ij} {t}_{aij} {\hat{O}}_{i j} \to {\sum }_{i} {t}_{ai} ( {\hat{b}}_{i} + {\hat{b}}_{i}^{†} ) ≡ {\sum }_{i} {t}_{ai} {\hat{B}}_{i}$$

The equivalence between fermion bath and boson bath is achieved if (in addition to the conditions mentioned above) the corresponding bath spectral functions S(ω) agree,

$${S}_{a}^{f} ( ω ) ≡ FT [ {\sum }_{ij} {t}_{aij}^{2} 〈 {\hat{O}}_{i j} ( t ) {\hat{O}}_{i j} ( 0 ) 〉 ] = {S}_{a}^{b} ( ω ) ≡ FT [ {\sum }_{i} {t}_{ai}^{2} 〈 {\hat{B}}_{i} ( t ) {\hat{B}}_{i} ( 0 ) 〉 ]$$

where FT denotes a Fourier transform. For the fermionic bath, the spectral function can take the following form:

$${S}_{a}^{f} ( ω ) = {\sum }_{ij} {t}_{aij}^{2} f ( {ϵ}_{i} ) [ 1 - f ( {ϵ}_{j} ) ] δ ( ω + {ϵ}_{i} - {ϵ}_{j} ) ,$$

where ƒ(ω) is the Fermi function

$$f ( ω ) = \frac{1}{exp ( \frac{ℏω - μ}{{k}_{B} T} ) + 1}$$

with the chemical potential μ. The spectrum of the bosonic bath can be described according to

$${S}_{a}^{b} ( ω ) = {\sum }_{i} {t}_{ai}^{2} [ 1 + {n}_{b} ( {ω}_{i} ) ] δ ( ω - {ω}_{i} ) + {\sum }_{i} {t}_{ai}^{2} {n}_{b} ( {ω}_{i} ) δ ( ω + {ω}_{i} )$$

where n_{b}(ωᵢ) is the Bose function according to

$${n}_{b} ( ω ) = \frac{1}{exp ( \frac{ℏω - μ}{{k}_{B} T} ) - 1}$$

However, it must be taken into account that various core orbitals can couple to the same bath modes. In this case, bath cross-correlations can occur, S_{a1,a2} (ω) ≠0. The cross-correlation functions in the cases considered can be described with

$${S}_{{a}_{1} , {a}_{2}}^{f} ( ω ) = {\sum }_{ij} {t}_{{a}_{1} ij} {t}_{{a}_{2} ij} ( {ϵ}_{i} ) [ 1 - f ( {ϵ}_{j} ) ] δ ( ω + {ϵ}_{i} - {ϵ}_{j} )$$

$$and$$

$${S}_{{a}_{1} , {a}_{2}}^{f} ( ω ) = {\sum }_{i} {t}_{{a}_{1} i} {t}_{{a}_{2} i} [ 1 + {n}_{b} ( {ω}_{i} ) ] δ ( ω - {ω}_{i} ) + {\sum }_{i} {t}_{{a}_{1} i} {t}_{{a}_{2} i} {n}_{b} ( {ω}_{i} ) δ ( ω + {ω}_{i} )$$

These functions must also ultimately agree, in order to achieve equivalence of the baths.

As a result, it can be achieved that, in all cases considered, the interaction between the core and the bath can be represented by a coupling between the core and a bosonic field with a certain spectral function. In the following, it is assumed that the bath consists of a large number of modes that couple to the core, so that the spectrum can be assumed to be continuous.

A further step of the method according to the invention is the mapping of the quantum mechanical system on the quantum computer or a more general quantum device. Here, the degrees of freedom of the core are mapped to the qubits of the quantum computer. In the case where the core consists of spins, the mapping is obvious, and each spin can be mapped to a qubit. However, if the core consists of fermions, each fermionic orbital can be mapped to a qubit—for example, by means of a Jordan-Wigner mapping.

The bath is instead mapped to a number of quantum elements. The number of quantum elements can be smaller than the number of elements, e.g., bosonic modes, in the bath.

The quantum elements may, for example, be linear oscillators, e.g., coaxial lines, resonators or LC resonant circuits, non-linear oscillators, e.g., LC resonant circuits with built-in Josephson junction, or (further) qubits, which can have a different design than the core qubits and can, for example, have different coherence properties.

In the case where the quantum elements are nonlinear, the excitation number of each individual quantum element should remain sufficiently small so that nonlinearity effects remain small. A linear quantum element can be equivalent to a bosonic field and thus has a Gaussian statistic in equilibrium. It is important to note that the quantum element can have a finite coherence: Decoherence leads to a broadening of the spectral peaks that can be mapped to the original model.

An important variable in the mapping of the bath to quantum elements is the spectral function that an element of the quantum system, more precisely of the core, e.g., a spin or a fermionic orbital, senses from the bath. The latter have already been introduced above. For an element a of the core, which couples to the bath via operators O, the spectral function is defined as

Sₐ^{core element}(ω)≡FT[Σᵢⱼtₐᵢ² [symbol] Ôᵢ(t)Ôᵢ(0) [symbol] ].

Examples of fermionic and bosonic baths and core elements have already been introduced above.

In order to map the bath to the quantum elements, the spectral function that a qubit of the quantum computer senses from the quantum elements is also needed. If a qubit a couples to quantum element i with a coupling strength tₐᵢ via operators Xₐᵢ, the spectral function sensed by the qubit can be written as follows:

Sₐ^{qubit}(ω)≡FT[Σᵢⱼtₐᵢₖ² [symbol] Xₐᵢ(t)\hat{X}ₐᵢ(0) [symbol] ].

The operators X and the coupling strengths t can be freely selected, or controlled and adjusted, via the digitally generable eigentime evolution U_{QC} or, in the case of resonators or coaxial lines, additionally via tunable couplings and resonance frequencies.

This allows the spectral function of the qubits to be manipulated until it agrees with the spectral function of the bath exactly or approximately, i.e., until

Sₐ^{qubit}≈Sₐ^{core element}

has been achieved for all elements of the core and all qubits of the quantum computer. Achieving this equality can be crucial for mapping the bath to the properties of the quantum elements. The spectral function that can be seen by the qubits representing the core must reproduce the spectral function of the corresponding core orbitals of the simulated model as well as possible. Here, it can be assumed that the qubits assigned to the core are noise-free.

An example of the effect of decoherence of quantum elements is, for example, the broadening of the qubit energy level if the quantum element is a qubit, or of the microwave resonator frequency if the quantum element is a resonator, to form a Cauchy distribution (Lorentzian). This broadening can generally be assumed for quantum elements under the influence of decoherence or noise. The spectral function, as seen by a qubit of the quantum computer, then is

$${S}_{a}^{qubit} ( ω ) = {\sum }_{i} {t}_{ai}^{2} \frac{1}{π} \frac{{γ}_{i}}{{γ}_{i}^{2} + {( ω - {ω}_{i} )}^{2}}$$

where γᵢ describes the broadening of quantum element i. This may, for example, be the decoherence rate of qubit i if the quantum element i is a qubit, or the coupling of microwave resonator i to a coaxial line if the quantum element i is a resonator. The parameter tₐᵢ describes the coupling strength between qubit and quantum element i.

For the sake of simplicity, it can be assumed that the hardware of the quantum computer has a temperature of zero (n_{b}=0). In addition, the parameters tₐᵢ, ωᵢ can be freely selected, or controlled and adjusted, via the digitally generable eigentime evolution U_{QC} or, in the case of resonators or coaxial lines, additionally via tunable couplings and resonance frequencies. That is to say, while the broadening γ is determined by the intrinsic decoherence or resonator linewidth of the quantum elements, the spectral function sensed by the qubits can be manipulated until it agrees with the spectral function of the bath, which can be simulated according to

Sₐ^{qubit}=Sₐ^{core element}

Achieving this equality can be crucial for mapping the bath to the properties of the quantum elements. The spectral function that can be seen by the qubits representing the core must reproduce the spectral function of the corresponding core orbitals of the simulated model as well as possible. Here, it can be assumed that the qubits assigned to the core are noise-free.

Equality can also be achieved by adjusting couplings and resonance frequencies and, for example, by adjusting them by means of an optimization routine or fitting routine. Alternatively, methods such as machine learning may also be used to find an optimal mapping.

In the case where the qubits assigned to the core are not completely noise-free, an additional step can be introduced, in which these remaining error sources are also mapped to a quantum mechanical system to be simulated. Such remaining errors (for example, decoherence or gate errors) in the qubits assigned to the core can be mapped to an effective temperature or to disorder.

In the case of decoherence (for example, decay, dephasing, or depolarization) of the qubits, the error can, for example, be described by a spectral function S_{decoh} (ω). This describable spectral function can be included in a bosonic function seen by this core orbital, in order ultimately to be able to form an effective spectrum. This additional part can be taken into account if, for example, the parameters tₐᵢ, ωᵢ were determined via the digitally generated eigentime evolution U_{QC}.

In this case, the total spectral density and condition for the mapping could read as follows:

$${S}^{qubit , total} ( ω ) = {S}^{qubit} ( ω ) + {S}_{decoh} ( ω ) = {S}^{score element} ( ω )$$

Here, the last equation is the fitting condition that is to be achieved in order to be able to map the bath to the properties of the quantum elements.

In the case of depolarization of the qubits, the additional contribution results S_{decoh} (ω) directly results in an increase of the temperature of the entire bath. In the case of decay of the qubits, the mapping can likewise take place in the form of an increased temperature of the bath. This can, for example, take place by reversing the logical states of the qubits, assigned to the core, between Trotter steps or via a certain number of quantum operations.

The dephasing of the qubits assigned to the core can also be mapped to the temperature of the bath—for example, if the noise transitions do not depend upon the state energies. Again, this can again take place by rotating the core qubits between Trotter steps. Gate errors (=errors in the generation of quantum operations due, for example, to incorrectly calibrated control signals) can be mapped to disorder. For example, a random overrotation in a two-qubit gate can be mapped to a disorder term in the coupling between two spins.

Furthermore, according to the method according to the invention, the simulation of the quantum mechanical system is carried out. This may, for example, mean that operations or control signals are applied to the quantum computer, so that a temporal evolution of the core-bath system defined in the previous steps can be obtained. The required control signals are prepared on a conventional computer unit and executed by a control unit on the quantum computer.

In order to be able to simulate the temporal evolution of the core-bath system, control signals can, for example, be applied to the quantum computer so that the real temporal evolution of the quantum computer due to the applied control signals corresponds to or at least approximates the temporal evolution of the quantum mechanical system to be simulated.

Simply put, the temporal evolution of both systems should be the same:

$$U ( t ) = T exp [ - i {\int }_{0}^{t} H ( {t}^{′} ) {dt}^{′} ] \approx {U}_{qc} ( t )$$

Here, U_{qc}(t) represents the temporal evolution of the quantum computer that simulates the temporal evolution of the quantum mechanical system to be simulated up to time t. More precisely, this can define that each expectation value of a time-dependent observable or a time-dependent correlation function, which were measured in the original quantum mechanical system or, after being mapped to the quantum computer, and on the quantum computer, must be the same or must at least be approximated to a certain accuracy, e.g., chemical accuracy.

This would mean, for example, that the following applies for an observable O of the original quantum mechanical system and the observable O_{qc} on the quantum computer

$$〈 ψ \vert U ( t ) {OU}^{†} ( t ) \vert ψ 〉 \approx 〈 {ψ}_{qc} \vert {U}_{qc} ( t ) {O}_{qc} {U}_{qc}^{†} \vert {ψ}_{qc} 〉$$

or for a correlation function between two observables

$$〈 ψ \vert U ( t ) {AU}^{†} ( t ) B \vert ψ 〉 \approx 〈 {ψ}_{qc} \vert {U}_{qc} ( t ) {A}_{qc} {U}_{qc}^{†} {B}_{qc} \vert {ψ}_{qc} 〉 .$$

In order to carry out the unitary evolution of the system on a digital quantum computer, the Hamiltonian operator H can be split into partial Hamiltonian operators Hₚ, for which the unitary temporal evolution can be implemented on the quantum computer. Hₚ is the representation of the operator on the quantum computer. In other words, the full time evolution can be broken down into small time steps dt=t/n, and the temporal evolution can be applied sequentially for each of the n time steps.

The complete temporal evolution can take the following form:

$$U ( t ) \approx {U}_{qc} ( t ) = {\prod }_{m = 1}^{n} {\prod }_{p}^{} {e}^{- {iH}_{p , m} dt}$$

For n→∞, the temporal evolution considered here becomes exact. The Hamiltonian H_{p,m} is a representation of the Hamiltonian operator between the times m dt and (m+1) dt and can be chosen, for example, at the edge of a time step H_{p,m}=Hₚ (m·dt) or as a weighted average over the interval [(m−1) dt, (m+1) dt]. For a time-independent Hamiltonian operator, H_{p,m}=Hₚ is constant.

While the core is mapped to qubits and implemented with digital operations, the situation for the bath is different, since it is mapped to more general quantum elements. If qubits are used to represent the bath, the digital Trotterization can also be used for the bath. If the bath is instead represented by other quantum elements, such as resonators, there is no full digital control over the quantum elements representing the bath.

However, the couplings between, for example, resonators and qubits can be changed digitally and switched on and off, while the quantum elements evolve statically over time, so that the coupling between core and bath can still be realized with the method presented above.

For describing the quantum elements, a static Hamiltonian H_{qe,static} can thus be added to the digitally controlled Hamiltonian operator Hₚ. Depending upon the implementation details of the quantum mechanical system to be simulated or of the quantum hardware, some operations may also be applied to the static Hamiltonian operator.

In the case of resonators, the natural frequency of the resonator could be changed, for example, by means of electromagnetic fields or flux bias. Together with the static parts, the simulation on the quantum computer can take the following form:

$$U ( t ) \approx {U}_{qc} ( t ) = {\prod }_{m = 1}^{n} {\prod }_{p}^{} {e}^{- {iH}_{p , m} dt} {e}^{- i ( {H}_{qe , static} + {H}_{env , static} ) {τ}_{p , m}}$$

Here, τ_{p,m} is the time required to carry out the temporal evolution e^{-iHp,mdt} on the quantum computer. By design, the parts H_{p,m} and the static part H_{qe,static} implement the temporal evolution of the core-bath system without broadening, while the environment of the quantum computer induces broadening. Table 1 summarizes which parts of the quantum mechanical system to be simulated can be executed digitally and which can be executed statically, i.e., in analog form.

Table 1 shows which part of the quantum computer Hamiltonian operator can be used to carry out a temporal evolution of a component of the quantum mechanical system to be simulated.

| Quantum elements | Digital | Static (analog) |
|---|---|---|
| Qubits | Core, coupling between core | Decoherence |
| | and bath, bath | |
| Resonators, etc. | Core, coupling between core | Bath, decoherence |
| | and bath | |

In addition, it will often be the case that connectivity on the quantum computer is limited—for example, that each qubit of a superconducting chip is connected only to the nearest qubits and other quantum elements. In the extreme case, there is a chain of qubits, each of which can be connected to a quantum element and two neighboring qubits, as shown in FIG. 2A.

On the other hand, in many situations, there are also interactions between elements assigned to the core and elements assigned to the bath, which cannot interact directly with one another on the quantum computer.

In order to be able to implement a quantum mechanical system to be simulated on a quantum computer or a quantum device with limited topology, the method provides in an advantageous embodiment that a SWAP network method be applied.

This SWAP network method was introduced in order to be able to efficiently simulate certain types of fermionic systems (see in this regard, for example, Ian D. Kivlichan, Jarrod McClean, Nathan Wiebe, Craig Gidney, Alán Aspuru-Guzik, Garnet Kin-Lic Chan, and Ryan Babbush, Phys. Rev. Lett. 120, 110501—published Mar. 13, 2018, URL: https://journals.aps.org/prl/abstract/10.1103/PhysRevLett.120.110501). However, in the course of the invention presented here, this can also be used for the efficient implementation of a core-bath system on a quantum computer.

After the core has been mapped to the quantum computer, each qubit represents a specific element, e.g., a specific spin or a fermionic orbital, of the quantum mechanical system to be simulated.

The basic idea of the SWAP network method is to swap the spins or orbitals representing two neighboring qubits and to simultaneously apply the Hamiltonian operator H_{m,p} related to these spins or orbitals. By following a systematic swapping of spins or fermions on specific qubits, e.g., by alternately swapping spins or orbitals on even and odd qubits, it can be achieved that each spin or each orbital has neighbored every other spin or every other orbital at least once and has been located at least once on every qubit that is coupled with a specific quantum element.

In this way, it can be achieved on quantum computers with limited connectivity that each spin or each orbital of a core site can be coupled with every bath site.

An important detail is that, in the method presented here, no SWAP operations have to be carried out on quantum elements, since the quantum elements do not interact with one another. These operations are applied only to qubits. This leads to great simplification of the quantum algorithm.

### BRIEF DESCRIPTION OF THE DRAWINGS

These and other objects and features of the present invention ωill be more fully disclosed or rendered obvious by the following detailed description of the preferred embodiments of the invention, which is to be considered together with the accompanying drawings wherein like numbers refer to like parts, and further wherein:

FIG. 1 is a flow chart showing steps of an exemplary embodiment of the invention;

FIG. 2A is a schematic view showing a chain of qubits, each of which can be connected to a quantum element and two neighboring qubits;

FIG. 2B is a schematic view showing each qubit coupled to two quantum elements;

FIG. 2C is a schematic view showing the situation when there are more bath sites, i.e., quantum elements, than core sites, i.e., qubits;

FIG. 3 shows a schemata of two spins interacting with one another with energy U on a one-dimensional fermion lattice with nearest neighbor hopping with amplitude t and spin-fermion exchange coupling g;

FIG. 4A is a graph showing the spectral density of a bath represented by a spectral function;

FIG. 4B shows exemplary adjustment parameters obtained from the graph of FIG. 4A; and

FIG. 4C is a graph showing an exemplary numerical simulation of the temporal evolution of the expectation values <n>=<σ+σ_>.

### DETAILED DESCRIPTION OF THE PREFERRED EMBODIMENTS

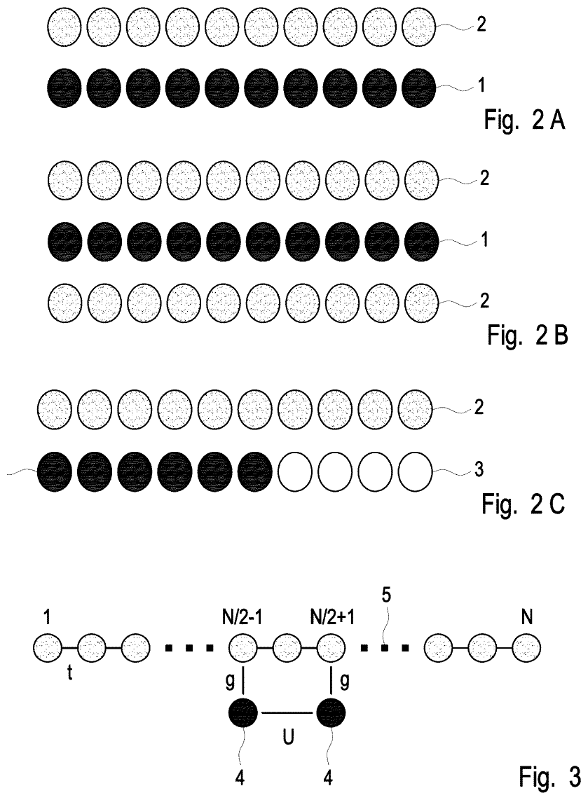

FIG. 2 shows several possibilities for how the core-bath system can be mapped on quantum computers with certain limited topologies. In FIG. 2A, each qubit 1 is coupled to one quantum element 2, whereas, in FIG. 2B, each qubit 1 is coupled to two quantum elements 2. The latter is advantageous, since it allows doubling the number of qubits 1 in the bath without increasing the number of SWAP processes. This is also a good choice if the method contains two different bath types.

FIG. 2C shows the situation when there are more bath sites, i.e., quantum elements 2, than core sites, i.e., qubits 1. In this case, more quantum elements 2 can be used than qubits 1, and the spins or orbitals on these qubits 1 can also be swapped in order to realize additional core-bath interactions. The core-bath system can always be mapped to linear chains of qubits 1 or quantum elements of quantum computers, and the SWAP network method can be used. This is not limited to one-dimensional quantum computer layouts. When using the SWAP network method, additional qubits 3 can be coupled to any number of quantum elements.

As soon as a steady state has been reached according to the method according to the invention, properties of the simulated system can be measured. A steady state can correspond to an eigenstate of the noisy system with an eigenvalue equal to zero. However, for a noisy system, the eigenstate can also be understood as a density matrix. Furthermore, a steady state can also be achieved, for example, by a very long temporal evolution or simulation of the system. A long simulation can be assumed, for example, if the time for which the system has been evolved is significantly longer than the decoherence rates in the system. An important quantity can be the energy of the core, which can be measured by measuring all operators of the Hamiltonian operator of the core, H_{core}.

For this purpose, the observables of interest, like the quantum mechanical system before, can be mapped to qubits. For spins, the mapping is obvious; fermions, for example, can be mapped to the qubits by means of a Jordan-Wigner transformation, comparably to what was described above. The measurement of the observable now corresponds to the measurement of the qubit operator that we can obtain through this transformation. A simple way to measure the observable can be to calculate the average by means of an operator.

After mapping to the quantum computer, the observable can take the form

Ô=Σⱼ^{j}oⱼΠₖσₖ^{α}^{ⱼ}^{,k}

where α is one of the operators {I,X,Y,Z}, σ^{α} is the corresponding Pauli matrix, and oᵢ is a prefactor. Each of the terms Πₖσₖ^{α}^{ⱼ}^{,k} corresponds to the product of individual measurements on the qubits in the basis of each Pauli operator, which are repeated many times in order to achieve statistical averaging.

The complete expectation value of the observable can be ascertained by simply adding the individual averages with the correct weighting (according to the prefactors). More complicated results, such as correlation functions, require the use of additional ancilla qubits.

For example, in order to be able to measure <A(t)B>, a Hadamard gate can first be applied to the ancilla qubits in order to subsequently apply A in a controlled manner to the qubits that represent the core, wherein the operation is controlled by the ancilla qubits. Thereafter, the temporal evolution is carried out, B is subsequently applied to the ancilla qubits in an anti-controlled manner, and the ancilla qubits are finally measured in the X and Y bases.

The invention is explained below in more detail on the basis of an exemplary embodiment.

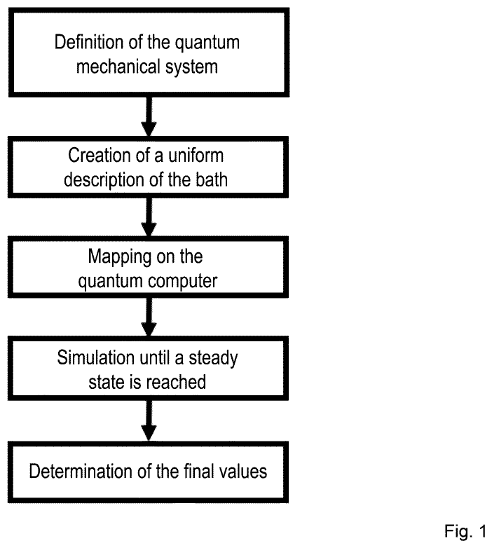

A simple implementation of the method according to the invention described here can be demonstrated for a certain number of spins lying on a one-dimensional fermion lattice. The individual steps of the exemplary embodiment are shown by way of example in FIG. 1. In the exemplary embodiment described here, the interacting spins are represented as the core, and the bath is represented in the form of fermions in a lattice. Spins can interact with one another with the energy U and can couple with fermions via local spin exchange according to

$${H}_{coupling} = {\sum }_{i} {g}_{i} ( {σ}_{i}^{+} {c}_{{x}_{i} ↓}^{†} {c}_{{x}_{i} ↑} + {σ}_{i}^{-} {c}_{{x}_{i} ↑}^{†} {c}_{{x}_{i} ↓} ) = {\sum }_{i} {σ}_{i}^{+} {\hat{F}}_{i}^{-} + {σ}_{i}^{-} {\hat{F}}_{i}^{-}$$

Here, the generation or annihilation of particles has been introduced at position xᵢ. This operator is a linear combination of eigenstate generation or annihilation operators,

$${c}_{{x}_{i}} = {\sum }_{j} {U}_{ij} {c}_{f}$$

which diagonalize the tight-binding Hamiltonian

$${H}_{bath} = {\sum }_{i} {tc}_{{x}_{i}}^{†} {c}_{{x}_{i + 1}} = {\sum }_{i} {ϵ}_{i} {c}_{i}^{†} {c}_{i}$$

The summation over the fermion spins is not explicitly listed here.

Once the quantum elements are identified, the spectral density of the bath can be represented.

The spectral function

$${S}_{a}^{f} ( ω ) = {\sum }_{ij} {t}_{aij}^{2} f ( {ϵ}_{i} ) [ 1 - f ( {ϵ}_{j} ) ] δ ( ω + {ϵ}_{i} - {ϵ}_{j} )$$

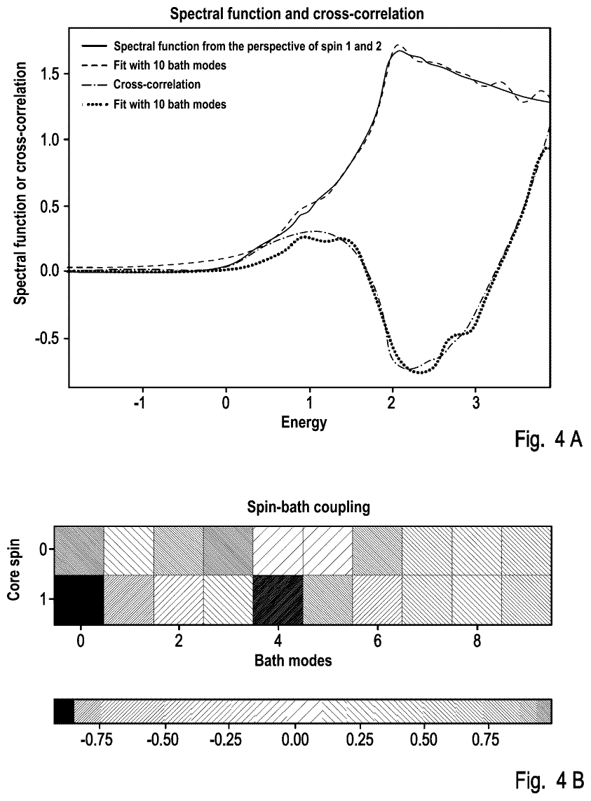

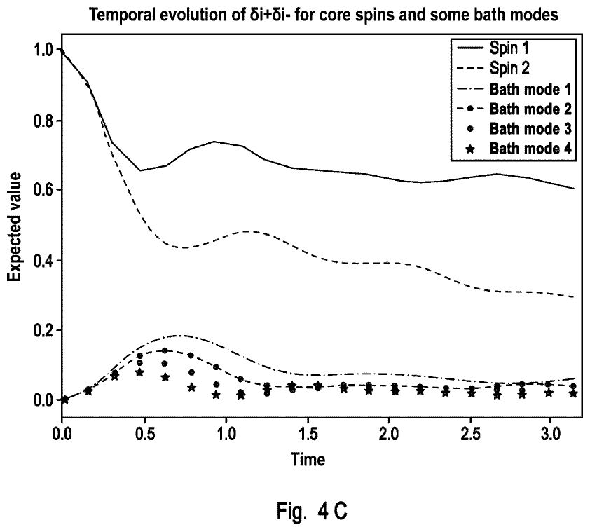

and its cross-correlations can be evaluated numerically, as shown by way of example in FIG. 4A. Here, two spins in the middle of the lattice are considered, as shown by way of example in FIG. 3. FIG. 3 shows a schemata of two spins 4 interacting with one another with energy U on a one-dimensional fermion lattice 5 with nearest neighbor hopping with amplitude t and spin-fermion exchange coupling g. In the exemplary numerical simulation shown in FIG. 3, the lattice sites at N=2,000 and the spin positions N=999 and N=1,001 are considered.

The spectrum in FIG. 4a can be adjusted by finding the optimal values for the couplings and energies of the bath by means of the least squares method. It is assumed that the decay of the bath modes (generated by the quantum elements) has a decoherence source. The decay of the different bath modes can be set to a common constant value, which is also adjusted accordingly in this example. This is possible because its relative size to other parameters, such as couplings and energy, is freely scalable, since the size of other parameters can be digitally controlled. By adjusting γ, only the absolute numbers of the other parameters are then determined. The corresponding spectral densities and cross-correlations are shown, by way of example, as dashed lines in FIG. 4A. The adjustment parameters thus obtained are shown by way of example in FIG. 4B.

Afterwards, the time evolution can be implemented on a quantum computer by digitally implementing the energies and couplings of core and bath. In particular, the bath can be realized here by multiple qubits. The bath is bosonic if the excitation numbers remain low, (<n>=(σ+σ_)≈0). After the quantum simulation has been carried out for some time, a quantity of interest can be measured. A numerical simulation of the temporal evolution of the expectation values <n>=<σ+σ_> is shown by way of example in FIG. 4C. Here, the simulation begins with all bath (core) qubits initially in their ground state (excited state), i.e., in the state with <n>=<σ+σ_>=0 (<n>=<σ+σ_>=1).

A method for simulating a quantum mechanical system by means of a noisy quantum computer is thus disclosed above, which makes use of the noise of the quantum computer, in particular the noise of the qubits or quantum elements, for simulating the quantum mechanical system.

### LIST OF REFERENCE SIGNS

1 Qubit
2 Quantum element
3 Unoccupied qubit
4 Spin
5 One-dimensional fermion lattice

1. Method for simulating a quantum mechanical system by means of a noisy quantum computer, which has at least one qubit (1) and at least one quantum element (2), wherein, in the simulation of the quantum mechanical system, the quantum mechanical system is assigned to the noisy quantum computer, and a measured variable of the quantum mechanical system is determined, characterized in that, in the simulation of the quantum mechanical system on the noisy quantum computer, parts of the quantum mechanical system are assigned to the noise of the quantum computer, wherein
the quantum mechanical system to be simulated is divided into a core and a bath,
the core is mapped to the at least one qubit (1),
the bath is mapped to the at least one quantum element (2) of the quantum computer, and
the noise of the at least one quantum element is assigned to at least one part of the quantum mechanical system, in particular the bath.

2. Method according to claim 1, characterized in that the bath is represented by a bosonic or fermionic system.

3. Method according to claim 2, characterized in that a uniform description of the bath is created.

4. Method according to claim 2, characterized in that the fermionic bath is transformed by means of a molecular field theory approximation.

5. Method according to claim 1, characterized in that the simulation of the quantum mechanical system is carried out on the quantum computer until a steady state is reached.

6. Method according to claim 1, characterized in that the at least one part of the quantum mechanical system that is assigned to the noise of the quantum elements (2) is mapped by means of a spectral function.

7. Method according to claim 1, characterized in that the quantum mechanical system consists of coupled spins (4), which couple to a fermionic (5) or bosonic system, wherein the spins (4) are assigned to the core, and the fermionic system (5) or bosonic system is assigned to the bath.

8. Method according to claim 1, characterized in that the quantum mechanical system is an interacting fermion system (5) in which one part of the orbitals of the fermion system (5) is assigned to the core and one part to the bath, and decoupling takes place between the orbitals assigned to the core and to the bath.

9. Method according to claim 8, characterized in that the decoupling takes place through a Schrieffer-Wolff transformation.

10. Method according to claim 8, characterized in that, for the orbitals of the fermion system (5), a distinction is made between spin-like orbitals and non-spin-like orbitals, and spin-like orbitals are assigned to the core and non-spin-like orbitals are assigned to the bath.

11. Method according to claim 8, characterized in that a local parity Pᵢ of the orbitals is measured, wherein the orbitals that satisfy the condition |−1−Pᵢ|<∈, i.e., have a parity close to −1, are assigned to the core.

12. Method according to claim 11, characterized in that, for a certain number of orbitals that do not satisfy the condition |−1−Pᵢ|<∈, an orbital rotation is carried out to minimize the parity, wherein the orbitals thus obtained, which now satisfy the condition |−1−Pᵢ|<∈, are treated as spin-like orbitals, and the orbitals that satisfy the condition |−1−Pᵢ|≥∈ are treated as non-spin-like orbitals.

13. Method according to claim 1, characterized in that noise of a non-ideal qubit (1) is likewise assigned to the bath.

14. Method according to claim 1, characterized in that at least one control signal is applied to the quantum computer in order to simulate a temporal evolution of the simulated quantum mechanical system, wherein a real temporal evolution of the quantum computer that is formed by the control signal corresponds or is at least approximated to the temporal evolution of the quantum mechanical system to be simulated.

15. Method according to claim 14, characterized in that the control signals are applied to the quantum computer in such a way that the quantum computer is brought into a state which corresponds to the steady state of the quantum mechanical system.

16. Method according to claim 1, characterized in that a SWAP network method is used to map the core and the bath on the quantum computer.

17. Method according to claim 5, characterized in that at least one measured value of an observable or a single-time correlation function or a multi-time correlation function of the simulated quantum mechanical system is determined from the achieved steady state.

18. Noisy quantum computer for executing a method according to claim 1, comprising at least one qubit (1) and at least one quantum element (2), wherein the noisy quantum computer has means for mapping the quantum mechanical system on the noisy quantum computer.

19. Noisy quantum computer according to claim 18, characterized in that the noisy quantum computer has means for creating and executing control signals.
